(19) United States
(12) Patent Application Publication
(10) Pub. No.: US 2009/0077638 A1
(43) Pub. Date: Mar. 19, 2009

(54) Setting and synching preferred credentials in a disparate credential store environment

(75) Inventors: James M. Norman, Pleasant Grove, UT (US); Cameron Mashayekhi, Salt Lake City, UT (US); Karl E. Ford, Highland, UT (US)

Correspondence Address: KING & SCHICKLI, PLLC, 247 NORTH BROADWAY, LEXINGTON, KY, 40507, US

(73) Assignee: Novell, Inc.

(21) Appl. No.: 11/901,397

(22) Filed: Sep. 17, 2007

(51) Int. Cl. G06F 21/00

(52) U.S. Cl. 726/5

(57) ABSTRACT

Apparatus and methods are described for using preferential credentials in an environment of multiple disparate credential stores. For at least two disparate credential stores, credential information is known, including a preferred credential indicated by a user. Upon indication of a desire to link another credential information to the preferred credential information, the two are mapped to one another. Users can sign-on, singularly, with the preferred credential information, and have access to both the disparate credential stores. A credential value can be shared by multiple credential ID's or one credential ID can be associated with multiple credential values thereby giving users the ability to cross-reference secrets and credentials for most efficiency. Default credentials are also possible as are retrofits for existing SSO services. Policy applications, computer program products and computing network interaction are other noteworthy features.

### FIELD OF THE INVENTION

Generally, the present invention relates to computing environments involving heterogeneous credential stores with disparate credential information. Particularly, it relates to coordinating the disparateness of the stores into harmonized versions to provide management from a single point of control, including setting a credential of one application as a preferred or default credential and using it relative to many other applications. Credentials themselves have proprietary structures based on the type of the stores they are saved in and these credentials are encrypted using different cryptographic algorithms and methods. Therefore, in the absence of a standard format and cryptographic algorithm in the field, the format and the components of credentials vary from store to store. However, regardless of the difference of formatting and encryption based on the proprietary implementations most of the credentials have essential and common components such as Identifiers (IDs) and Secrets. Identifiers are the type of data used to select or introduce the owner of the credential to the target authentication system and commonly is stored in the clear (not encrypted). Secrets are the inherently encrypted component of the credential that are only owned or known to the owner of the data that should be encrypted to protect security and integrity of the credential (such as passwords or keys stored on smart cards). In various embodiments, a single credential value can be shared by multiple credential ID's or one credential ID can be associated with multiple credential values thereby giving users the ability to cross-reference secrets and credentials for most efficiency. Default credentials are also possible as are retrofits for existing SSO services. Policy applications, computer program products and computing network interaction are other noteworthy features.

### BACKGROUND OF THE INVENTION

Newer computer operating systems such as Linux, Windows XP, or Windows Vista provide multiple credential stores for network client applications' usage. These credential stores usually are utilized to provide mechanisms for applications to store credentials for the user, and retrieve them later to provide a single-sign-on (SSO) experience. More famous of these credential stores by name are: Firefox password manager, Gnome Keyring, KDE Wallet, Windows Passport, CASA, SecretStore etc.

Applications, based on their needs or at the time of their development, are closely integrated with a particular credential store. This is due to applications utilizing different credential stores and different types. As a result, there is a need for a single point of administration and access for the user. Currently, however, users must launch different management utilities for each store to manage their credentials. Presently, there are no tools available to provide the ability to copy, move, or link credentials among different versions of the same applications or multiple applications sharing the same credential. To allow credentials to be available for use and management in different stores, currently you have to manually create, copy, or delete them from one store to another. Intuitively, this is inconvenient and impractical.

Also, it presently exists that each credential store has proprietary interests in only offering solutions focused on their store and not interoperability with other stores, thereby avoiding ease of use for end users.

In view of these various problems, there is need in the art of credential stores to provide a mechanism to synchronize the values of credentials between stores, thereby eliminating the need for manually maintaining credentials in multiple stores. There is also a need to be able to conveniently set and synchronize credentials with one another so as to eliminate tediousness in user management of credentials. In that many computing configurations already have existing SSO technology, it is further desirable to leverage existing configurations by way of retrofit technology, thereby avoiding the costs of providing wholly new products. Taking advantage of existing frameworks, such as the CASA (Common Authentication Service Adapter) software offering by Novell, Inc., the common assignee of this invention, is another feature that optimizes existing resources. Any improvements along such lines should further contemplate good engineering practices, such as automation, relative inexpensiveness, stability, ease of implementation, low complexity, flexibility, etc.

### SUMMARY OF THE INVENTION

The foregoing and other problems become solved by applying the principles and teachings associated with the hereinafter-described setting and synching preferred credentials in a disparate credential store environment. At a high level, methods and apparatus are provided that allow linking of credentials amongst different stores and provide access to them through a utility that provides for a single point of access and management. This is contemplated to be particularly useful when there are multiple versions of the same application such as a web based, command line, GUI, and perhaps older and newer versions that might have different methods of storing credentials in different stores. Linking will provide the ability to manage from a single point as well as synchronization of credentials regardless of credential store of origin. It also provides a mechanism to synchronize the values of credentials between stores, eliminating the need for manually maintaining credentials in multiple stores by the user. The user simply changes one value in a given credential and all linked or synchronized values will be updated automatically. In addition, policies can be applied to expand or filter credential availability across different stores.

In one particular embodiment, the invention contemplates setting a single credential as a preferred or default credential and using it as the primary reference for all other applications. As an example, CASA captures a desktop credential, such as username and password. In turn, the desktop credential can be set as the preferred or default credential and used for the email, database, spreadsheets, or other common applications in the desktop environment.

In other embodiments, the invention provides the means for a single credential value to be shared by multiple credential ID's or one credential ID to be associated with multiple credential values thereby giving gives the user the ability to cross-reference secrets and credentials for most efficiency. In this regard, a programmatic interface is provided to allow the applications to query a preferred secret in a credential store and link to it and use it. Association of credentials and applications consuming the credentials are also potentially policy based, i.e., if a corporate policy prohibits the use of setting the desktop credential as a default, the user would not be allowed to configure this scenario. On the other hand, a policy could allow for it and the desktop credential could be used for all others.

Particular apparatus and methods of the invention contemplate at least two disparate credential stores, including a preferred credential indicated by a user. Upon indication of a desire to link another credential information to the preferred credential information, the two are mapped to one another. Users then sign-on, singularly, with the preferred credential information, and have access to both the disparate credential stores. Default credentials are also possible as are retrofits for existing SSO services. Policy applications, computer program products and computing network interaction are other noteworthy features. In any embodiment, users are provided the means to set and use a preferred credential and, heretofore, no other SSO service provider has such functionality.

In still other particular embodiments, a synchronizing engine requests and receives past and present credential information from the disparate credential stores. Users indicate which, if any, of the credential information they desire to synchronize together. Upon common formatting of the credential information, comparisons reveal whether differences exist between the past and present versions. If differences exist, the information is updated.

In a computing system environment, the invention may be practiced with: a user interface module for indicating a preferred credential information (such as by way of a CASA manager); a single-sign-on service; a synchronizing engine interfacing with the single-sign-on service and the user interface module; and at least two credential stores having dissimilar credential information. During use, the synchronizing engine is configured to receive the preferred credential indicated by a user via the user interface module and map other credential information thereto.

Computer program products are also disclosed. For instance, a product available as a download or on a computer readable medium has components to: request and receive credential information from at least two multiple disparate credential stores; commonly format the credential information; and map a preferred of the credential information to another of the credential information.

The CASA architecture is also exploited as part of the invention to leverage existing resources.

These and other embodiments of the present invention will be set forth in the description which follows, and in part will become apparent to those of ordinary skill in the art by reference to the following description of the invention and referenced drawings or by practice of the invention. The claims, however, indicate the particularities of the invention.

### BRIEF DESCRIPTION OF THE DRAWINGS

The accompanying drawings incorporated in and forming a part of the specification, illustrate several aspects of the present invention, and together with the description serve to explain the principles of the invention. In the drawings:

FIG. 1 is a diagrammatic view in accordance with the present invention of a representative computing environment for coordinating credentials across disparate credential stores;

FIG. 2 is a diagrammatic view in accordance with the present invention of a more detailed representative computing environment for coordinating credentials across disparate credential stores;

FIG. 3 is a high-level flow chart in accordance with the present invention for coordinating credentials across disparate credential stores;

FIG. 4 is a representative diagrammatic view in accordance with the present invention for establishing policy or linking credentials of disparate credential stores;

FIGS. 5A and 5B are representative diagrammatic views in accordance with the present invention for searching and replacing credential information;

FIG. 6 is a flow chart in accordance with the present invention for searching and replacing credential information; and

FIGS. 7 and 8 are flow charts in accordance with the present invention for setting and synching preferred credentials in a disparate credential store environment.

### DETAILED DESCRIPTION OF THE ILLUSTRATED EMBODIMENTS

In the following detailed description of the illustrated embodiments, reference is made to the accompanying drawings that form a part hereof, and in which is shown by way of illustration, specific embodiments in which the invention may be practiced. These embodiments are described in sufficient detail to enable those skilled in the art to practice the invention and like numerals represent like details in the various figures. Also, it is to be understood that other embodiments may be utilized and that process, mechanical, electrical, arrangement, software and/or other changes may be made without departing from the scope of the present invention. In accordance with the present invention, methods and apparatus for coordinating credentials across disparate credential stores are hereinafter described, including setting and synching preferred credentials.

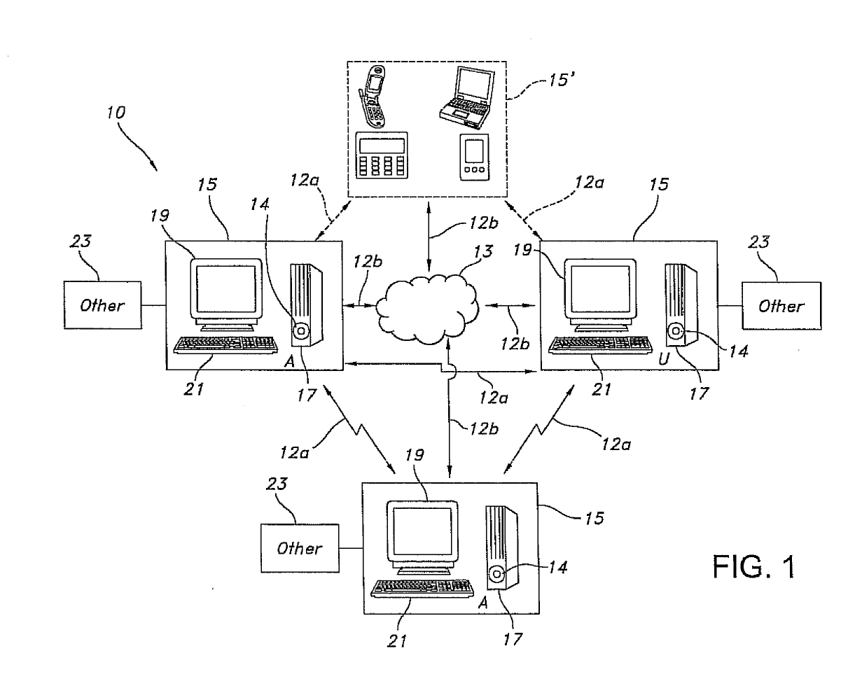

With reference to FIG. 1, a representative computing environment 10 for coordinating credentials occurs by way of one or more computing devices 15 or 15′ arranged as individual or networked physical or virtual machines. In a traditional sense, an exemplary computing device typifies a server 17, such as a grid or blade server. Alternatively, it includes a general or special purpose computing device in the form of a conventional fixed or mobile computer 17 having an attendant monitor 19 and user interface 21. The computer internally includes a processing unit for a resident operating system, such as DOS, WINDOWS, MACINTOSH, VISTA, UNIX, and LINUX, to name a few, a memory, and a bus that couples various internal and external units, e.g., other 23, to one another. Representative other items 23 include, but are not limited to, PDA's, cameras, scanners, printers, microphones, joy sticks, game pads, satellite dishes, hand-held devices, consumer electronics, minicomputers, computer clusters, main frame computers, a message queue, a peer machine, a broadcast antenna, a web server, an AJAX client, a grid-computing node, a peer, a virtual machine, a web service endpoint, a cellular phone, or the like. The other items may also be stand alone computing devices 15′ in the environment 10 or the computing device itself.

In either, storage devices are contemplated and may be remote or local. While the line is not well defined, local storage generally has a relatively quick access time and is used to store frequently accessed data, while remote storage has a much longer access time and is used to store data that is accessed less frequently. The capacity of remote storage is also typically an order of magnitude larger than the capacity of local storage. Regardless, storage is representatively provided for aspects of the invention contemplative of computer executable instructions, e.g., software, as part of computer program products on readable media, e.g., disk 14 for insertion in a drive of computer 17. Computer executable instructions may also be available as a download or reside in hardware, firmware or combinations in any or all of the depicted devices 15 or 15′.

When described in the context of computer program products, it is denoted that items thereof, such as modules, routines, programs, objects, components, data structures, etc., perform particular tasks or implement particular abstract data types within various structures of the computing system which cause a certain function or group of functions. In form, the computer product can be a download or any available media, such as RAM, ROM, EEPROM, CD-ROM, DVD, or other optical disk storage devices, magnetic disk storage devices, floppy disks, or any other medium which can be used to store the items thereof and which can be assessed in the environment.

In network, the computing devices communicate with one another via wired, wireless or combined connections 12 that are either direct 12a or indirect 12b. If direct, they typify connections within physical or network proximity (e.g., intranet). If indirect, they typify connections such as those found with the internet, satellites, radio transmissions, or the like, and are given nebulously as element 13. In this regard, other contemplated items include servers, routers, peer devices, modems, T1 lines, satellites, microwave relays or the like. The connections may also be local area networks (LAN) and/or wide area networks (WAN) that are presented by way of example and not limitation. The topology is also any of a variety, such as ring, star, bridged, cascaded, meshed, or other known or hereinafter invented arrangement.

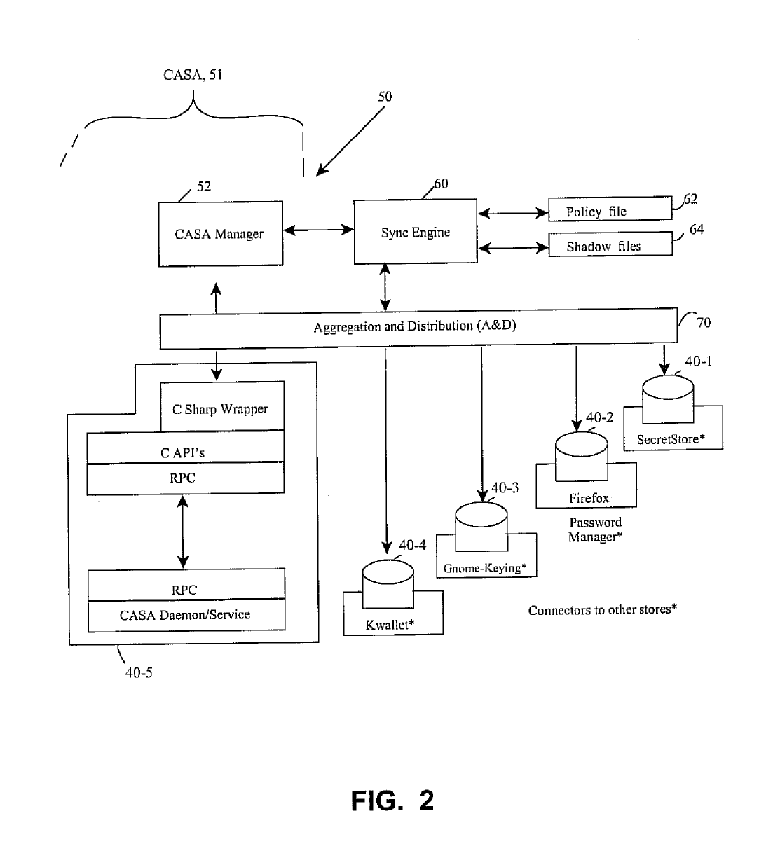

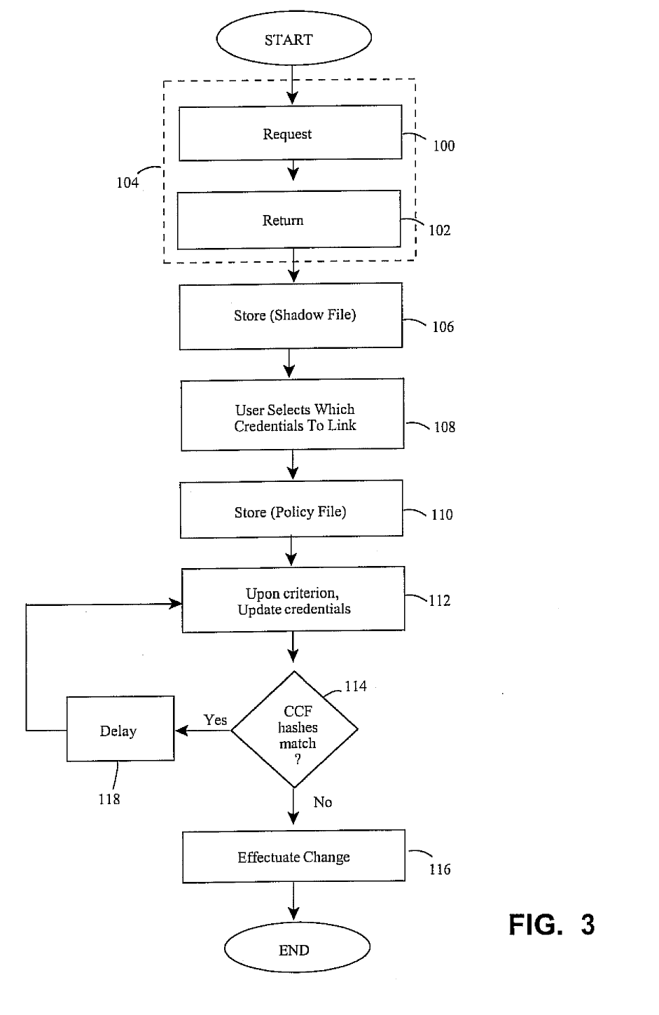

With the foregoing representative computing environment as backdrop, FIGS. 2 and 3 show a high-level architecture and overall flow of one aspect of the invention. That is, a plurality of disparate credential stores 40-1, 40-2, 40-3, 40-4, 40-5 have dissimilar credential information, such as keys, passwords, or other secrets, based primarily on the propriety nature of the store. Representatively, the stores include, but are not limited to, SecretStore, Firefox Password Manager, Gnome Keyring, KDE Wallet and miCASA, respectively. A single-sign-on service 50 in the computing environment consists of one or more existing applications that are useful to the user for enjoying SSO convenience from one or more computing devices. In that the disparateness of the stores 40 tends to complicate SSO, especially considering that credential information is updated over time, is inconsistent in form or storage from one store to the next, has little if any commonality amongst the stores, etc., the invention further includes a synchronizing engine 60 (with attendant files 62, 64) and a layer 70 intermediate the stores 40 and the synchronizing engine. During use, users indicate which, if any, of the credential information they desire to synch together and, upon common formatting of the credential information by way of the synch engine 60 and layer 70, all linked or synchronized information is updated automatically.

In more detail, Novell Inc.'s CASA brand software (Common Authentication Services Adapter) 51 is a common authentication and security package that provides a set of libraries for application and service developers to enable single sign-on for an enterprise network. Version 1.7, for example, provides a local, session-based credential store (called miCASA) that is populated with desktop and network login credentials, given generically as 40-5. A CASA manager 52 serves as user interface module, such as on monitor 19 (FIG. 1), whereby users can undertake the linking of credentials of the various stores 40.

Currently, CASA manager contains drivers/connectors to the credential stores 40. Upon request, each of these drivers return an enumeration of credentials through a common interface and in a common format, steps 100 and 102. (Together, this is referred to as a Common Credential Format (CCF), step 104.) In a representative embodiment, the format is an XML schema and each driver produces an XML document describing the credential information of the stores 40. So that the CASA manager 52 and the stores 40 have format commonality, the layer 70 is configured there between. Otherwise, the CASA manager interfaces with users as normal and the credential stores keep their own proprietary format.

Upon the return, one embodiment of the invention contemplates storing the credential information as a shadow file 64, step 106. A hash of the credential information occurs at this time and is likewise stored with the shadow file. The user, through the CASA Manager, can then select the various credentials they wish to link together or synchronize, step 108. In one embodiment, this is referred to as a symbolic link and is stored in the policy file 62, step 110, for use by the synchronizing engine.

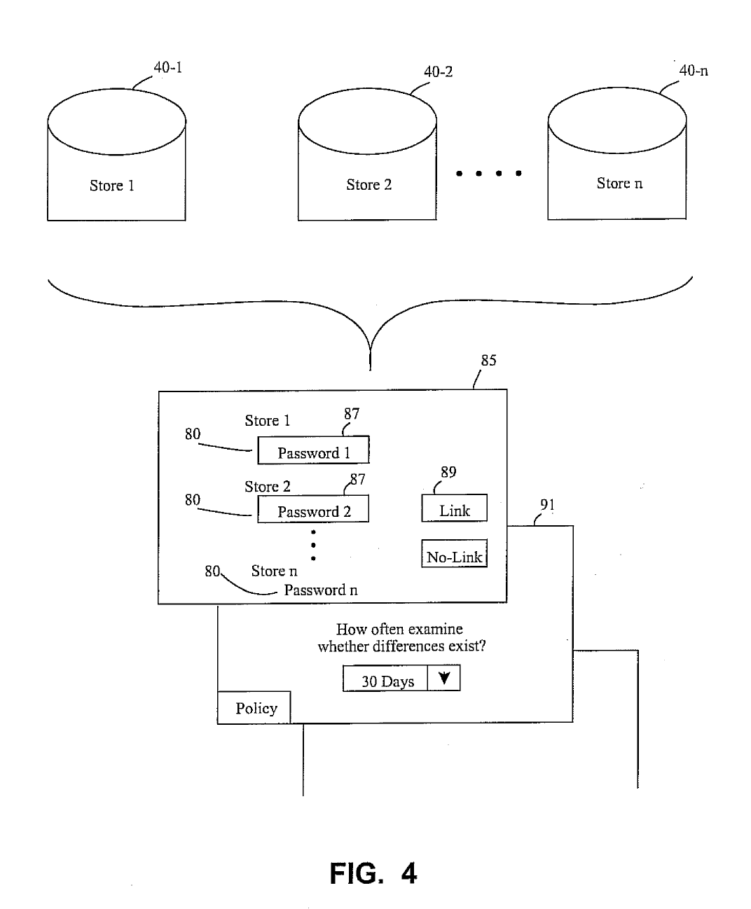

Diagrammatically, FIG. 4 shows various credential stores 40-1, 40-2, . . . 40-n, returning various credential information 80, such as Password 1, Password 2, . . . Password n, to the user interface module, such as per screen shots or web pages 85 on a monitor of a computing device. In turn, the user selects which of the credentials 80 they desire to synch together. In this case, each of Password 1 and Password 2 are selected, such as by a highlighting box 87, and are linked by clicking on a dedicated linking icon button 89. Of course, those skilled in the art will recognize other techniques for linking credential information of the various stores together.

Returning to FIGS. 2 and 3, upon reaching a criterion, such as a configured interval or based on some trigger policy, the synchronizing engine 60 updates the earlier version of credentials, step 112, by requesting and receiving a new CCF document from each driver. It computes a new hash for the latest or updated version and compares it to the hash earlier-stored in the shadow file(s). If the hashes match, the credential information remains accurate and no further updating is necessary, other than to delay for some pre-defined period, step 118, and repeat the process, e.g., steps 112, and 114. On the other hand, if the hashes do not match, changes are effectuated at step 116. In a representative embodiment, change effectuation consists of the sync engine 60 comparing the CCF documents of the current request with the shadow request. Based on policy, changes are then made either to the shadow file, the target store, or both. The sync engine also queries the symbolic link information file for linked credential keys. If needed, changes to the linked shadow files are propagated to the appropriate store.

For instance, if a user or enterprise policy requires a user to update their single-sign-on password every 30 days, such as per 91, FIG. 4, and the user's password for their Firefox account has not changed, the foregoing allows the inquiry to examine when and if the passwords for the SSO and Firefox are different. If different, the invention recognizes it and effectuates an invisible change to the user such that they can still enjoy a SSO experience, without needing to go back to their Firefox account and change their password, and login credentials to match their SSO password. In other words, the present invention recognizes that users often desire to keep many passwords updated together, without actually having to undertake the work necessary to keep them updated, and accomplishes the change for the individual automatically.

For example, Firefox stores a credential as a username and a password for services requiring authentication. Often, other applications using the same username and password for authentication store that information as a cn (common name) and a pin. The user will recognize that the password saved by Firefox is the same information saved as the pin by another application in a different store. This invention allows the user to link or synchronize the password saved by Firefox with the pin saved by the other application. Hence, when the password changes so does the pin.

In the alternative, however, it should be appreciated that users may want to avoid any linking whatsoever of credential information and so a mechanism, such as default condition of no-linking (absent an affirmative indication of linking) or a no-linking icon button 93, FIG. 4, can be used in certain instances. In this manner, credentials can be kept strictly isolated if desired.

In the case of conflicts, resolution can be accomplished by the policy the user sets up while creating a link between two or more credential keys. In this regard, the policy might be to treat a particular store as Master and another as a Servant, to select a hierarchy of stores having priority over other stores, or to let the user resolve the conflict manually using an Administration or other tool. The policy may also be a time frame, a security measure, combinations thereof, or any hereinafter contemplated feature useful in defining conditions on the linking.

To conveniently provide the ability to set and use preferred credential information as the only credential information in an SSO environment, or one of a few credentials in a limited credential environment, reference is taken to FIG. 7. At step 300, users indicate which of the credential information for the many different credential stores is their preferred one. At step 302, upon determining that users desire to synch the preferred credential to another credential, such as by synching the preferred credential to all other credentials, or to a limited number of other credentials, a map is created, step 304. In a CASA environment, this means the CASA manager 52 (FIG. 2) serves as a user interface module, such as on monitor 19 (FIG. 1), whereby users can undertake the foregoing steps. Also, CASA 51 captures the credential information from the disparate credential stores, such as from Desktop logins, GroupWise, iPrint, Client32, iFolder, Firefox Plugin, and other CASA enabled applications.

With reference to FIG. 8, one embodiment for mapping credential information occurs first by identifying those applications with credential information, step 350, and second by retrieving the credential information per a specific one of the applications, step 352. For instance, each application stores its credential under a proprietary ID, such as GroupWise. Because a user might want to synchronize their GroupWise credential with their Desktop credential, the credential store utility would provide a way for a query for the GroupWise credential to map to the Desktop credential or any other credential.

At step 354, it is then undertaken to determine whether any mapping already exists for various credential information. If so, the mapping is displayed at step 356. If not, users will undertake mapping of their preferred credential by entering a link (step 358), e.g., the user will map their Group Wise to the Desktop, in continuing the previous example. Alternatively, if a policy, such as a corporate policy relating to security, allows for it, the user may avoid mapping altogether and just have a default credential entered for the mapping at step 358.

Similarly, if a user already has a mapping displayed at step 356 and they desire to change the mapping at step 360, they simply enter the link or have a default credential entered at step 358. Otherwise, the processing ends.

### EXAMPLE

Each identified application (identified under the heading Application ID, in the map TABLE below) sets and retrieves credentials using one of two credential ID's, e.g., Group Wise or Desktop. By way of the earlier-described framework, the ID's passed from the application are mapped to any other ID. By way of the user interface module, the application identified as gmail.novell.com is now linked to Group Wise under the link/mapping ID heading in the map TABLE below. On the other hand, if a corporate policy allows it, the user may map alternatively to the Desktop credential, such as per the application iFolder. Under the Credential ID heading, this is a reference to a location where data resides in a tag. Ultimately, this allows network applications to sign on seamlessly in an SSO environment using a common credential.

An embodiment of the invention actually uses a look up TABLE as representatively shown here:

| Application ID | link/Mapping ID | Credential ID |
|---|---|---|
| Desktop | | Desktop |
| Group Wise | Group Wise | Group Wise |
| gmail.novell.com | Group Wise | |
| iFolder | Default | Desktop or any other |

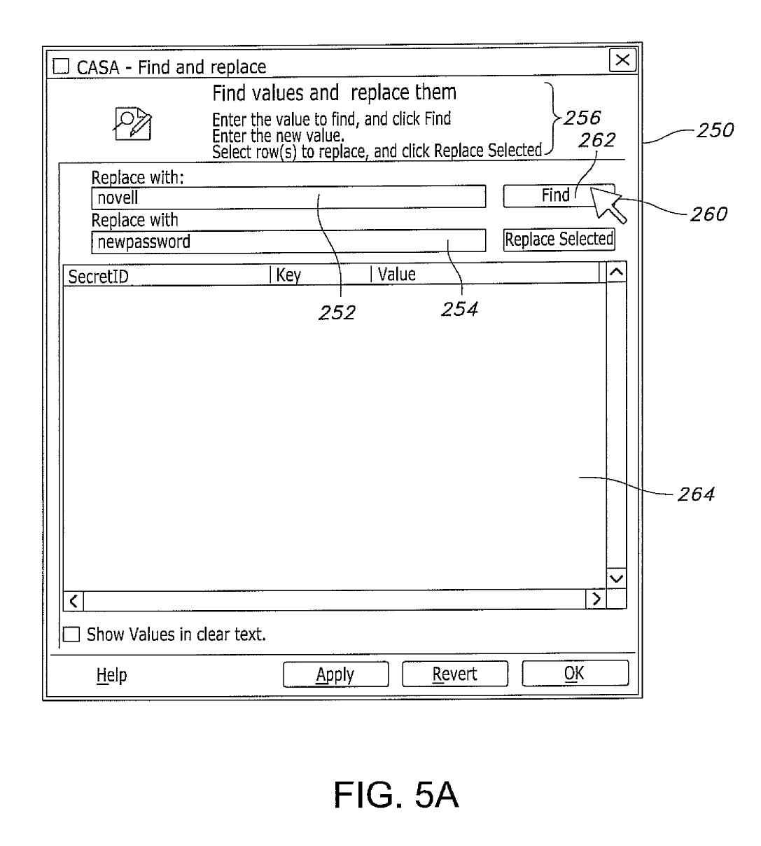

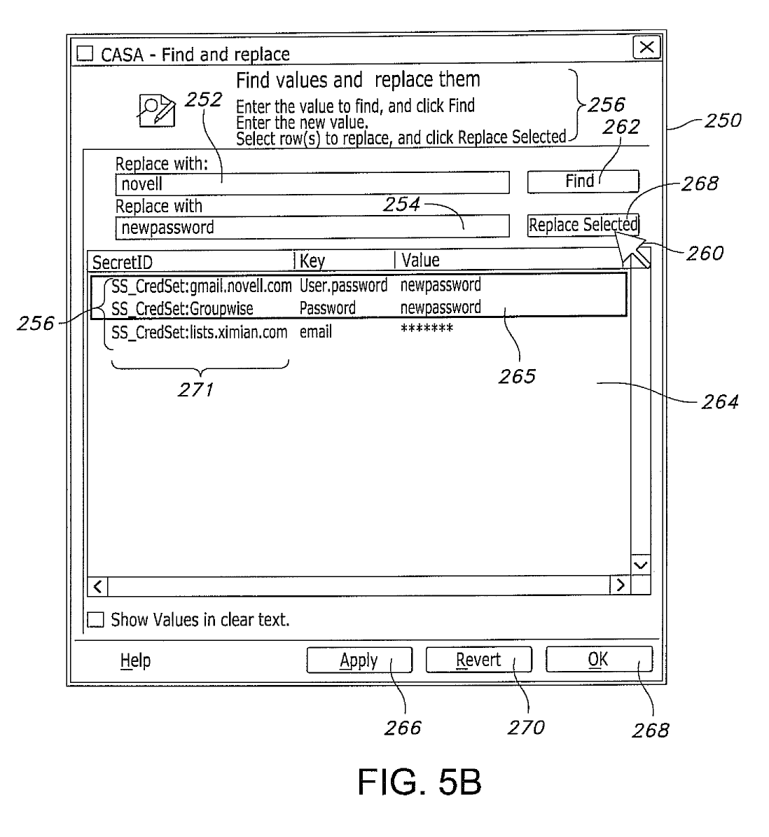

Appreciating users will likely have many different credentials amongst the various credential stores, convenient locating and replacing of these is another aspect of the invention. With reference to FIGS. 5A, 5B, and 6, a first embodiment contemplates launching a credential store utility at step 200. In so doing, the foregoing described functionality of linking credential information is made available, including the common formatting of disparate credential information from disparate credential stores. At step 202, by way of a search and replace feature of the utility, users can then locate their credential information, from whatever store, and change it in quantity or singularly, or by way of any other criteria.

At steps 204 and 206, it is contemplated that authentication (dashed box, 207) of the user's authority occur in order to proceed with further manipulation of credential information. Thus, the utility prompts the user for an entry of a master password (such as that corresponding to login in the SSO environment), step 204, and upon appropriate entry and verification of same, step, 206, users have been authenticated. The credential stores then become available for general use and users may proceed with changing credential information. On the other hand, if the master password is improper, users are again re-prompted for the master password at step 204 with the ability to proceed with changing credentials upon passing at step 206. Optionally, it may be desirable to prevent further processing with the search and replace feature of the utility if the user cannot eventually authenticate him- or herself. Thus, optional step 208 provides the prevention of further functionality after a predetermined number of failures (such as 1, 2, 3, etc.) has occurred at step 206.

To the extent the user's authority has been authenticated at step 206, this now means the presentation of a user-interface dialog, e.g. box 250 on a monitor 19 (FIG. 1), that accepts entry of search and replace fields 252, 254 at step 210. As described in the user-interface instructions 256, users simply enter a “value” to “find,” or be searched-for, (in this instance the word Novell). They then “click Find,” such as by using a pointing device 260 on the icon 262 labeled “Find.” The utility then searches the credential stores for values matching that of the search field 252.

At step 212, the results 263 of the Find are populated and displayed in a portion 264 of the user-interface dialog, whereby users make selections (indicated by shading 265) of the credential information they desire to change. Upon entry of an appropriate “Replace with” value 254, (in this instance the word “newpassword”), users “click Replace Selected” 256, such as by using the pointing device 260 on the icon 268 labeled “Replace Selected.” At step 212, the changes are committed. In this manner, users can singularly or collectively change mismatched credential information. It is also the case that users need not know how many passwords or other identifying secrets are available to them, per the various credential stores, because the invention identifies all credential information having common values and gives the users an opportunity to link them together, or not.

In alternative embodiments, changes in credential information can be committed, by way of clicking on any of the icons labeled “Apply” 266 or “OK” 268, or upon selection of the “enter” key found on most computing keyboards.

In a reverse embodiment, it may be desirable that users want to undo earlier linking of credential information. In this regard, a “Revert” icon 270 is provided whereby users have functionality to restore credential information of any particular credential store, e.g., 271, back to an earlier or original setting. Other options for this also include a “Restore Default” functional icon (not shown) or the like.

In any embodiment, certain advantages and benefits over the prior art should be readily apparent. For example, but not limited to, the invention provides advantage over the art according to: 1) the ability to link and synchronize credentials across multiple stores according to application(s) of policy; 2) providing an “umbrella service” giving users a single point of use, management, and administration for multiple credential stores. (Compared to the prior art, others focus on proprietary solutions, not interoperability between stores.); 3) overcoming complexity in the working environment of standard operating systems. (An illustration of this relates to current Linux distributions that, by default, provide the two popular choices of desktops (Gnome, and KDE) and each come with its own credential store and the applications that use one or the other, but not both. Now users can utilize the instant invention and use all effectively.) Appreciating complexity in computing environments, other expansions to the invention include, but are not limited to: adding peer-to-peer linking and synchronization capability for users to synchronize their multiple desktops (e.g., peer-to-peer Windows brand workstations linked to peer-to-peer Linux desktops, or vice versa); or having linking capability between clients and servers (e.g., linking desktop credential store(s) to eDirectory SecretStore); and 4) the ability to apply uniform policy across disparate stores through a single point of management. In other embodiments, it is a feature to set and use a preferred credential, including or not policy determinations per various credential mappings.

In still other embodiments, the invention gives users the ability to affirmatively search for and find credential information amongst disparate stores for the purpose of conveniently changing one or more together from a single point of control. The searching and replacing feature also provides a mechanism whereby users can fully understand how many passwords, secrets, keys, etc., they have over the many disparate stores available to them and affirmatively control their relationship to other credential information. Un-linking of credential information is still another advantage over the art. In any event, the invention allows maintaining seamless and uninterrupted SSO service.

Finally, one of ordinary skill in the art will recognize that additional embodiments are also possible without departing from the teachings of the present invention. This detailed description, and particularly the specific details of the exemplary embodiments disclosed herein, is given primarily for clarity of understanding, and no unnecessary limitations are to be implied, for modifications will become obvious to those skilled in the art upon reading this disclosure and may be made without departing from the spirit or scope of the invention. Relatively apparent modifications, of course, include combining the various features of one or more figures with the features of one or more of other figures.

1. In a computing system environment, a method of using preferential credentials in an environment of multiple disparate credential stores, comprising:
determining credential information for at least two said multiple disparate credential stores;
identifying one of the credential information as a preferred credential;
indicating a desire to link another credential information to the preferred credential information; and
mapping the preferred credential information to the another credential information.

2. The method of claim 1, wherein the mapping further includes identifying applications having said credential information.

3. The method of claim 1, wherein the mapping further includes establishing a default credential.

4. The method of claim 1, wherein the identifying the preferred credential further includes supplying the preferred credential in a lookup table.

5. The method of claim 1, further including commonly formatting the credential information for the at least two said multiple disparate credential stores.

6. The method of claim 1, wherein the determining credential information further includes conducting a user search.

7. The method of claim 1, further including launching a credential store utility providing a common interface with a common format for the credential information.

8. The method of claim 7, further including retrofitting an existing single-sign-on service with the credential store utility.

9. The method of claim 1, further including establishing a policy for the preferred credential.

10. The method of claim 1, further including determining whether a mapping of the preferred credential already exists.

11. In a computing system environment, a method of using preferential credentials in an environment of multiple disparate credential stores, comprising:
searching for credential information for at least two said multiple disparate credential stores;
receiving the requested credential information through a common interface in a common format;
mapping a preferred of the credential information to another of the credential information; and
upon signing-on with the preferred credential information, having access to both the at least two said multiple disparate credential stores.

12. The method of claim 11, wherein the mapping further includes establishing a default credential.

13. The method of claim 11, further including changing the mapping for the preferred credential information.

14. The method of claim 11, further including launching a credential store utility providing the common interface with the common format.

15. The method of claim 11, further including establishing a policy for the preferred credential.

16. A computer program product available as a download or on a computer readable medium having executable instructions for using preferential credentials in an environment of multiple disparate credential stores, comprising:
a first component for requesting and receiving credential information for at least two said multiple disparate credential stores;
a second component to commonly format the credential information; and
a third component to map a preferred of the credential information to another of the credential information.

17. The computer program product of claim 16, further including a fourth component causing display of a user interface module whereby users can said map the preferred credential information.

18. The computer program product of claim 16, further including a fourth component providing access to both the at least two said multiple disparate credential stores upon a user signing-on with the preferred credential information.

19. The computer program product of claim 16, wherein one or more of the components resides for retrofitting with an existing single-sign-on service.

20. A computing system for using preferential credentials in an environment of multiple disparate credential stores, comprising:
a user interface module for indicating a preferred credential information;
a single-sign-on service;
a synchronizing engine interfacing with the single-sign-on service and the user interface module; and
at least two credential stores having dissimilar credential information, wherein the synchronizing engine is configured to receive the preferred credential said indicated by a user via the user interface module and map another credential information thereto, the preferred credential information and the another credential information being one credential of the dissimilar credential information.
